(19) United States
(12) Patent Application Publication
(10) Pub. No.: US 2019/0251703 A1
(43) Pub. Date: Aug. 15, 2019

(54) METHOD OF ANGLE DETECTION

(71) Applicant: Apical Limited, Cambridge (GB)

(72) Inventor: Vladislav TEREKHOV, Loughborough (GB)

(21) Appl. No.: 16/279,753

(22) Filed: Feb. 19, 2019

Related U.S. Application Data
(63) Continuation of application No. PCT/GB2017/052258, filed on Aug. 3, 2017.

(30) Foreign Application Priority Data
Aug. 19, 2016 (GB) 1614233.3

(51) Int. Cl. G06T 7/73

(52) U.S. Cl. CPC G06T 7/73; G06T 2207/30244

(57) ABSTRACT

Certain examples described herein relate to a method for detecting a tilt angle between a camera coordinate system and a world coordinate system. In one such example, the method comprises receiving an image and detecting a plurality of lines in the image, wherein each detected line has an associated angle. The method then comprises, based on at least a first set of the lines, determining at least a first parameter indicating a first representative angle corresponding to the first set. Finally, the method comprises determining the tilt angle based on the at least one parameter.

### CROSS-REFERENCE TO RELATED APPLICATIONS

This application is a continuation of International Application No. PCT/GB2017/052258, filed Aug. 3, 2017, which claims priority to UK patent application no. 1614233.3, filed Aug. 19, 2016, under 35 U.S.C. § 119(a). Each of the above-referenced patent applications is incorporated by reference in its entirety.

### BACKGROUND OF THE INVENTION

### Technical Field

The present invention relates to methods and apparatus for determining the tilt angle of a camera.

### Background

It is frequently desirable to detect a tilt angle of a camera. Methods for determining such a tilt angle typically require the camera to comprise a tilt sensor, for example to correct for camera tilt in captured images.

### SUMMARY

According to a first aspect of the present invention, there is provided a method for detecting a tilt angle between a camera coordinate system and a world coordinate system. The method comprises: receiving an image; detecting a plurality of lines in the image, wherein each detected line has an associated angle; based on at least a first set of the lines, determining at least a first parameter indicating a first representative angle corresponding to the first set; and determining the tilt angle based on at least the first parameter.

In one example, the first set of lines comprises lines with corresponding angles within a first range and the method comprises identifying the first representative angle as corresponding to a first axis of the world coordinate system.

The first axis may be a horizontal axis of the world coordinate system, and in this case the method may comprise determining the tilt angle based on at least an angle of the first axis relative to the image.

In an alternative example, the first axis is a vertical axis of the world coordinate system, and the method comprises determining the tilt angle based on at least an angle of the first axis relative to the image.

In an embodiment, the method comprises: based on at least a second set of the lines, determining at least a second parameter indicating a second representative angle corresponding to the second set; and determining the tilt angle based on at least one of the first parameter and the second parameter.

The method may comprise: identifying the first representative angle as corresponding to one of a horizontal axis and a vertical axis of the world coordinate system; and identifying the second representative angle as corresponding to the other of the horizontal axis and the vertical axis of the world coordinate system.

In one example, the method comprises: selecting a preferred one of the first and second sets; and determining the tilt angle based at least on the parameter corresponding to the selected set.

The selecting said preferred one of the first and second sets may be based on a predefined characteristic of the image.

In an example, the method comprises: calculating an uncertainty corresponding to the first set and an uncertainty corresponding to the second set; selecting at least one of the first and second sets based on the calculated uncertainties.

In a further example, the method comprises determining the tilt angle based on an assumed relationship between the first representative angle and the second representative angle.

The method may comprise: identifying a candidate line break region in the image, wherein identifying the candidate line break region comprises identifying a first pixel of the image and a second pixel of the image, between which the candidate line break region appears, wherein: the first pixel has a first characteristic and the second pixel has a second characteristic with a predetermined similarity relationship to the first characteristic, and using the identified candidate line break region to assist in detecting a line in the image.

In accordance with a further aspect of the present disclosure, there is provided an apparatus for detecting a tilt angle between a camera coordinate system and a world coordinate system. The apparatus comprises a processor configured to: receive an image from a camera; detect a plurality of lines in the image, wherein each detected line has an associated angle; based on at least a set of the lines, determine at least a parameter indicating a first representative angle corresponding to the first set; and determine the tilt angle based on at least the parameter.

The processor may be configured to receive the image and determine the tilt angle in real time. The tilt angle may be a mounting angle of the camera.

In accordance with a further aspect, there is provided a non-transitory computer-readable storage medium comprising a set of computer-readable instructions stored thereon which, when executed by at least one processor, cause the at least one processor to: receive an image from a camera; detect a plurality of lines in the image, wherein each detected line has an associated angle; based on at least a set of detected lines with angles within a pre-defined angular range, determine at least a parameter indicating an average angle of the lines of the set; and determine a tilt angle between a camera coordinate system and a world coordinate system based on at least the parameter.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a flow diagram of a method for detecting a line in an image according to an embodiment;

FIG. 2 shows an example image comprising a candidate line break region;

FIG. 3 shows an example image comprising light and dark regions;

FIG. 4 shows an example scheme for quantising gradient angles;

FIG. 5 shows a schematic representation of a histogram of gradient amplitude in an image;

FIGS. 6A to 6C show an example contiguous region of an image through which a candidate line component may be identified;

FIG. 7 shows a schematic representation of an apparatus according to an embodiment;

FIG. 8 shows a schematic representation of a non-transitory computer-readable storage medium according to an embodiment;

FIG. 9 shows a flow chart of a method for detecting a tilt angle according to an embodiment;

FIGS. 10A and 10B show a schematic representation of an image having a tilt angle;

FIG. 11 shows a schematic representation of an apparatus according to an embodiment; and

FIG. 12 shows a schematic representation of a non-transitory computer-readable storage medium according to an embodiment.

### DETAILED DESCRIPTION

Below, methods and apparatus for determining a tilt angle between a camera coordinate system and a world coordinate system will be described. First, however, we will describe an embodiment of line detection, which includes improved line detection based on identifying and utilising a candidate line break region.

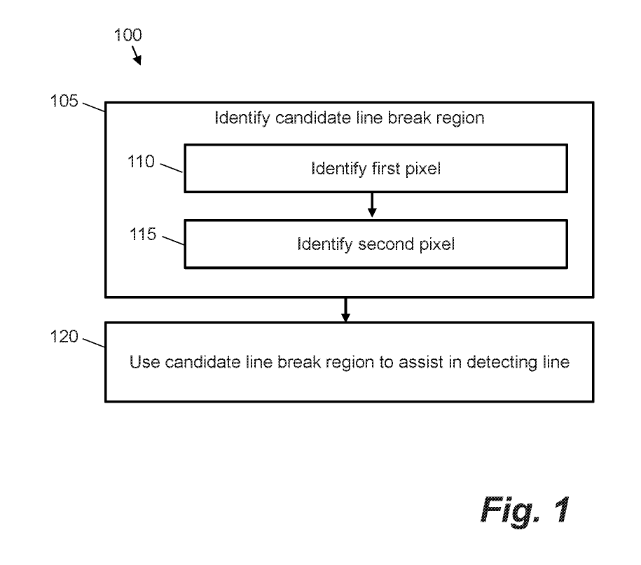

FIG. 1 shows a flow diagram of a method 100 for detecting a line in an image according to an embodiment. The image may for example comprise a still image, or a frame of a video. The method comprises an identifying step 105 in which a candidate line break region is identified in the image. Identifying the candidate line break region comprises a step 110 of identifying a first pixel of the image and a step 115 of identifying a second pixel of the image, between which the candidate line break region appears. In the present disclosure, a “pixel” is a subdivision of the image. It may be a single element of the image or, alternatively, a group of elements such as a 4×4 square.

Following identification of the candidate line break region, the method 100 comprises a step 120 of using the candidate line break region to assist in detecting a line in the image, as will be described in more detail below.

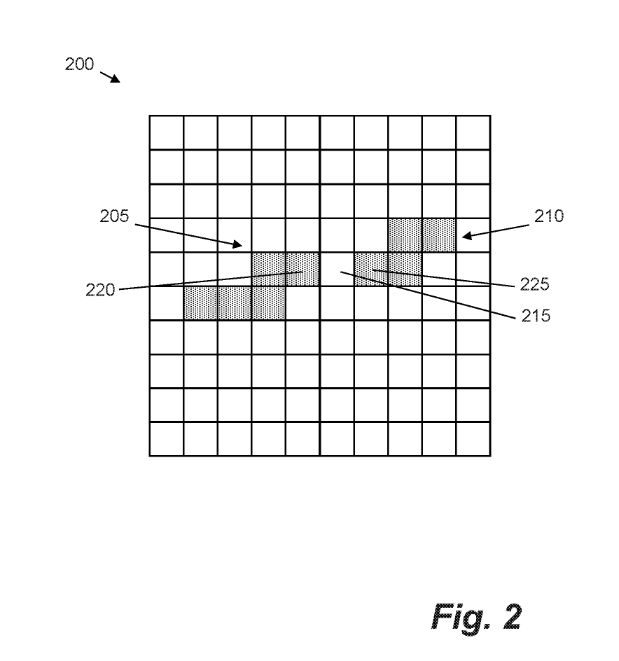

FIG. 2 shows an image 200 comprising two regions of pixels 205, 210, separated by a pixel 215. Known image detection algorithms may detect the regions 205, 210 as separate lines. The present method may identify pixel 220 as the first pixel and pixel 225 as the second pixel, and thus identify pixel 215 as the candidate line break region.

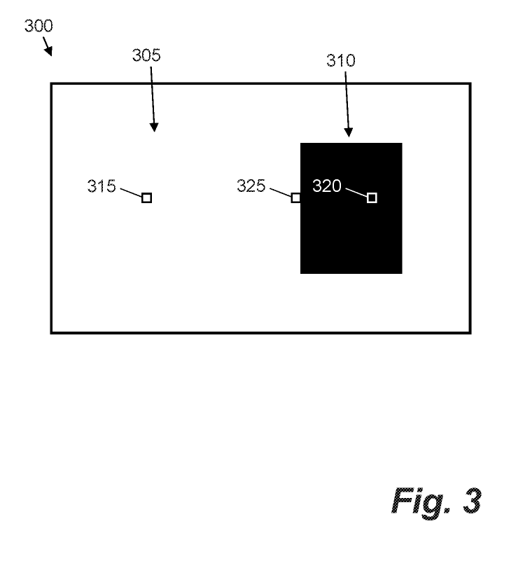

FIG. 3 shows an image 300 comprising a uniform light region 305 and a uniform dark region 310. A gradient amplitude and/or angle may be associated with pixels of the image. These may be determined using a Sobel filter, which produces a gradient amplitude and gradient angle for each pixel. These values may be stored as a gradient amplitude matrix, or bitmap, and a gradient angle matrix, or bitmap, representing the gradient amplitude and gradient angle, respectively, of each pixel. In embodiments, one or each of these bitmaps are updated by having new values assigned as described below. The bitmap or bitmaps are thus enhanced for the purposes of line detection.

As an example of gradient amplitude and angle, a pixel 315 in the middle of the uniform light region 305 would have a gradient amplitude of zero, as would a pixel 320 in the middle of the uniform dark region 310. A pixel 325 at the boundary of the light region 305 and dark region 310 would have a high gradient amplitude, and would have a gradient angle perpendicular to the border between the light region 305 and dark region 310.

Returning to FIG. 1, in the method 100 the first pixel has a first characteristic and the second pixel has a second characteristic with a predetermined similarity relationship to the first characteristic. The first and second characteristics may for example be respective first and second gradient angles. For example, the predetermined relationship may be such that the second gradient is equal to the first gradient angle, or that the second gradient is within a predefined range of the first gradient angle.

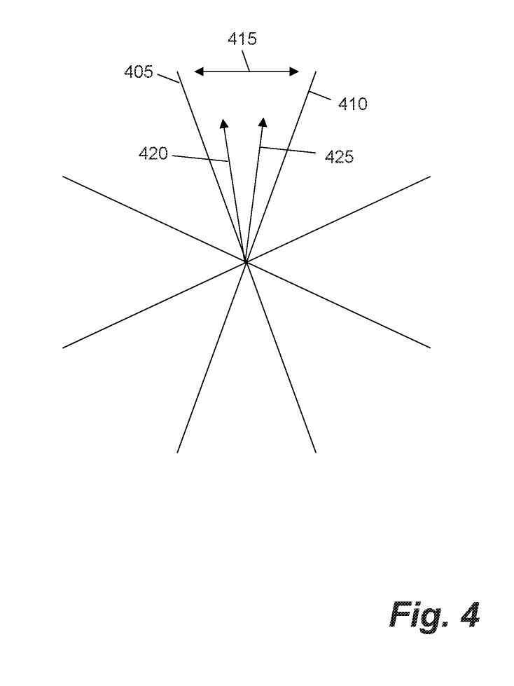

In one example, the first and second gradient angles are quantised gradient angles. FIG. 4 shows an example scheme for quantising gradient angles. A full range of 360° is divided into angular ranges, such as the angular range 405 defined by angles 410 and 415. In this example, the range 405 is centred on the vertical. Pixels with gradient angle within the range 415 are assigned the same quantised gradient angle which, in this example, is a vertical. For example, angles 420 and 425 both lie within the range 415 and thus correspond to the same quantised angle. The angular ranges may be the same size, as shown, or may differ in size. The number of angular ranges into which to divide the full 360° may be selected based on a trade-off of processing efficiency and accuracy of line detection results. For example, increasing the number of angular ranges would typically provide more accurate line detection results, but would be less computationally efficient. In examples in which the first and second angles are quantised gradient angles, the predetermined relationship of the second gradient angle to the first gradient angle may be that the second gradient angle is equal to the first gradient angle.

Returning to FIG. 1, at block 120 the identified candidate line break region is used to assist in detecting a line in the image. For example, where two detected lines such as 205 and 210 in FIG. 2 are separated by the candidate line break region, such as pixel 215 as shown in FIG. 2, it may be determined that the two lines 205, 210 should be combined into a single line running through the candidate line break region 215. Various known methods of line detection, as described below, may be used. Line detection may be repeatedly performed on the image, whereby to detect multiple lines present in the image. The detected lines may be used as an input to many known image processing techniques, for example pattern recognition and/or object classification.

In some examples, the candidate line break region contains a pixel identified to have a predetermined difference relationship to the first and second pixels. For example, the predetermined relationship may be such that the pixel of the candidate line break region is identified to have a gradient amplitude lower than a gradient amplitude of the first pixel and/or lower than a gradient amplitude of the second pixel. This may be achieved by requiring the first and second pixels to have gradient amplitude above a predefined threshold, and requiring the pixel or pixels of the candidate line break region to have gradient amplitude below the predefined threshold.

Alternatively or additionally, the predetermined difference relationship may be such that the pixel or pixels of the candidate line break region have gradient angles different from the gradient angle of the first pixel and different from the gradient angle of the second pixel.

In some examples, the candidate line break region has a predetermined size characteristic. For example, this characteristic may be that the candidate line break region has length equal to or less than a threshold. This threshold may be expressed as a number of pixels. For example, the line break may have length equal to a single pixel.

The method may comprise assigning to a pixel of the candidate line break region a gradient amplitude which is different to the original gradient amplitude of the pixel in the candidate line break region. This may be stored in the gradient amplitude bitmap, to generate an enhanced gradient amplitude bitmap. For example, with reference to FIG. 2, the pixel 215 of the candidate line break region may be assigned a gradient amplitude based on at least one of the gradient amplitude of the first pixel 220 and the gradient amplitude of the second pixel 225. For example, the pixel 215 of the candidate line break region may be assigned a gradient amplitude equal to the gradient amplitude of the first pixel 220 or the second pixel 225. As another example, the pixel 215 of the candidate line break region may be assigned a gradient amplitude equal to an average of the gradient amplitude of the first pixel 220 and the gradient amplitude of the second pixel 225. The detecting of the line in the image may then be based on the assigned gradient amplitude.

Alternatively or additionally, the method may comprise assigning to a pixel of the candidate line break region, for example pixel 215 of FIG. 2, a gradient angle based on at least one of the gradient angle of the first pixel 220 and the gradient angle of the second pixel 225. This may be stored in the gradient angle bitmap, to generate an enhanced gradient angle bitmap. For example, the pixel 215 of the candidate line break region may be assigned a gradient angle equal to the gradient angle of the first pixel 220 and/or equal to the gradient angle of the second pixel 225. As another example, the pixel 215 or pixels of the candidate line break region may be assigned a gradient angle equal to an average of the gradient angle of the first pixel 220 and the gradient angle of the second pixel 225.

Throughout the present disclosure where values, for example gradient amplitudes and gradient angles, are assigned to pixels, the assigned value may be stored in a shadow image instead of immediately changing the value of the pixel in the image. This allows each pixel of the image to be analysed in turn without the analysis being influenced by changes in values of surrounding pixels, and thus improves the accuracy of the analysis whilst requiring additional computing resources. After each assigned value is stored in the shadow image, the assigned values may then be copied back to the main image.

In some examples, the method comprises filtering the edge gradient of at least one pixel of the image, wherein the filtering comprises determining whether adjacent pixels have a predefined gradient amplitude relationship. For example, the filtering may comprise comparing in turn the gradient amplitude of each pixel of the image with the gradient amplitude of surrounding pixels, and modifying the gradient of a given pixel as a result of this comparison. As such, the filtering may be based on local feature analysis. In one example, the filtering comprises determining the differences between the gradient amplitude of a given pixel and the gradients of each surrounding pixel. The maximum of these gradient differences is then compared with a predefined threshold and, if the maximum gradient difference is below the threshold, the given pixel is assigned a gradient amplitude of zero. In this manner, areas of the image with low gradient amplitude, i.e. comparatively flat areas of the image, may be assumed to not comprise edges or lines and may thus be excluded from at least some further processing. This improves the computational efficiency of the method. The filtering step may be performed before determining candidate line break regions, such that the determining of candidate line break regions is based on the output of the filtering.

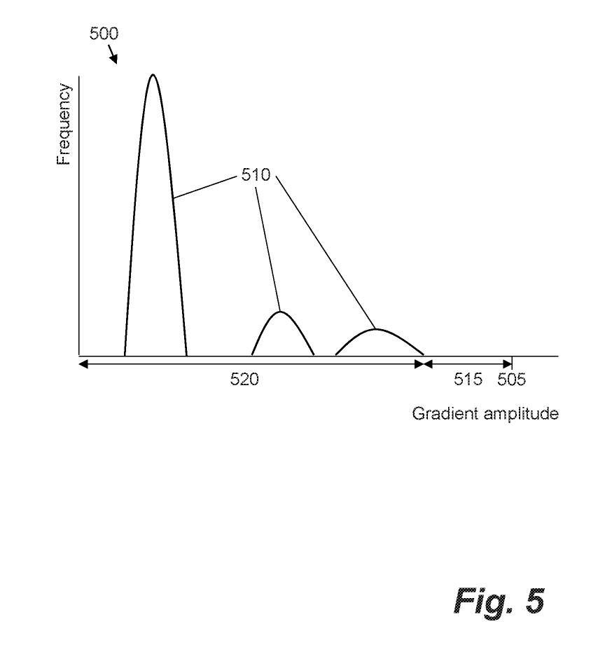

In some examples wherein filtering is performed based on a predefined threshold, as described above, the predefined threshold may be a fixed value. In other such examples, the threshold may be determined based on an analysis of gradient amplitudes in the image, as will now be described with reference to FIG. 5. A histogram 500 may be produced representing the frequency of occurrence of gradient amplitudes of pixels in the image, wherein gradient amplitudes range from zero to a maximum 505. For example, in an 8-bit image, the maximum gradient amplitude may be 255. Typically, the distribution of gradient amplitudes comprises peaks 510, and it is frequently the case that no pixels have gradient amplitude in a range 515 terminating at the maximum gradient amplitude 505. The presence and width of the range 515 depends on the specific image undergoing analysis. As such, all pixels of the image have gradient amplitudes within a range 520 from zero up to the highest gradient amplitude in the image, i.e. the lower limit of range 515.

In one example, the predefined amplitude threshold is set equal to the product of a constant value and an average, for example the mean, of pixel values over the range 520. For example, the average may be determined as:

$$average = \frac{{\sum }_{i = 0}^{k} a ( i )}{n}$$

where a(i) is the cumulative frequency of the gradient amplitude, k is the size of the histogram and n is the number of nodes, or bins, of the histogram over the range 520. The constant value varies according to the number of pixels surrounding a given pixel during the filtering procedure, and may be determined empirically based on analysis of a large number of images. For example, where the filtering procedure considers all the pixels in a 3×3 or 5×5 square surrounding the given pixel, the constant value may advantageously be between 1.8 and 2.4.

In some examples the method comprises, following the above-described filtering, identifying pixels with non-zero gradient surrounded by pixels with zero gradient and assigning a gradient of zero to these pixels. In this manner, lone pixels with non-zero gradient that do not form part of a potential line may be excluded from further processing. This increases computational efficiency. Computational efficiency may be further increased by identifying small isolated regions of pixels with non-zero gradient amplitude surrounded by pixels with zero gradient amplitude. For example, regions of connected pixels smaller than a 2×2 square may be identified, and their gradient amplitudes set to zero. These steps do not significantly reduce the quality of the line detection, as such small isolated pixels and/or regions are not likely to form part of lines.

In some examples the detecting 120 the line comprises performing a connected components analysis to identify regions of the image corresponding to respective line segments. For example, identifying such a region may comprise identifying a contiguous region comprising a plurality of pixels with given gradient characteristics. One example of such a characteristic is a gradient amplitude above a predefined threshold, for example the previously-defined amplitude threshold. Alternatively, where the above-described filtering is performed, one example of such a characteristic is a non-zero gradient amplitude. Another example of such a characteristic is a gradient angle equal to, or within a predefined range of, other pixels of the contiguous region. The contiguous region may have a predetermined size characteristic. For example, the contiguous region may have length and/or width above a predefined threshold. Contiguous regions with size below a size threshold may be ignored in further analysis to improve computational efficiency. The size threshold may be optimised based on a trade-off between memory requirements and accuracy of line detection.

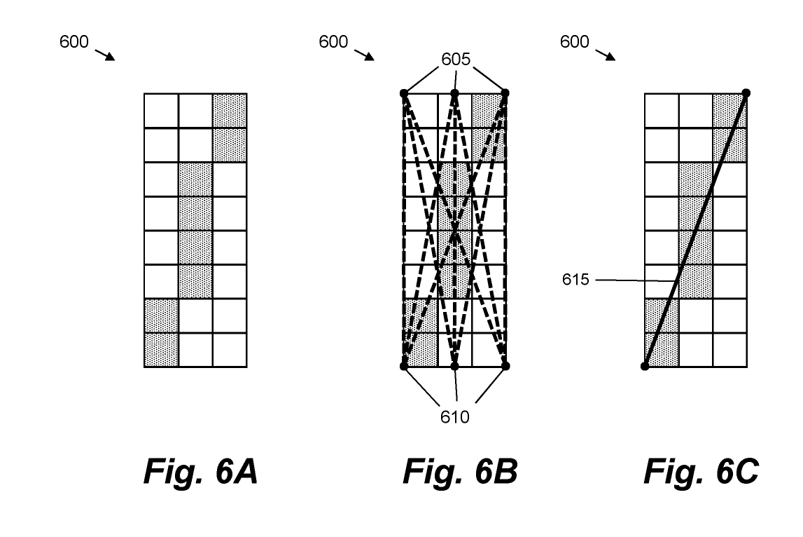

FIG. 6A shows an example 600 of such a contiguous region comprising pixels satisfying the gradient characteristics (shaded) and pixels not satisfying the gradient characteristics (not shaded). The method then comprises determining a best-fit line component through the contiguous region 600. The best-fit line component may be determined using a random sample consensus algorithm.

In one example, determining the best fit line component comprises determining whether the contiguous region 600 has a first predefined width characteristic and a first predefined height characteristic, wherein the height is greater than the width. For example, this may require the height to be greater than a long-edge threshold and require the width to be less than the short-edge threshold, such that the region 600 is comparatively tall and thin, as shown in FIG. 6A. Referring to FIG. 6B, if the region 600 has these characteristics, the present example comprises determining an error corresponding to each of a predetermined number of candidate line components (dashed lines) through the region 600. End points of each candidate line component lie at predefined positions 605 associated with the top edge, and at predefined positions 610 associated with the bottom edge of the region 600. For example, predefined positions 605 may be equally spaced along the top of the region 600, and predefined positions 610 may be equally spaced along the bottom of the region 600. Increasing the number of predefined positions produces more accurate results, but requires increased computational resources. As such, the number of predefined positions may be optimised based on a trade-off between desired accuracy and available processing resources. The method then comprises identifying as the best-fit line component the candidate line component with lowest corresponding error. For example, the error corresponding to a given candidate line component may be determined based on the distance of the centre point of each shaded pixel from the given candidate line component. FIG. 6C shows the region 600 with only the candidate line component 615 with lowest error.

Analogously, if the region 600 has a second predefined width characteristic and a second predefined height characteristic, wherein the width is greater than the height, the method comprises determining an error corresponding to each of a predefined number of candidate line components through the region 600, wherein end points of each candidate line component lie at predefined positions associated with the left-hand edge and right-hand edge of the region 600. The method then comprises identifying as the best-fit line component the candidate line component with lowest corresponding error.

If the region 600 does not have the first predefined width and height characteristics, and does not have the second predefined width and height characteristics, the method comprises determining the best-fit line component based on a regression analysis of the contiguous region.

In some examples, the number of predefined positions depends on the lesser of the height and width of the contiguous region. For example, the number of predefined positions may be equal to the lesser of the number of pixels corresponding to the height of the region 600 and the number of pixels corresponding to the width of the region 600. This is shown in FIG. 6B, in which the region 600 has a width of three pixels and wherein three predefined positions are associated with the top and bottom of the region 600.

The method may then comprise identifying the line in the image as comprising the line component 615. For example, this may comprise identifying connected line components as forming a single line in the image, for example by way of a Hough transform.

The present method allows detection of lines which may not have been detected without taking into account candidate line break regions as described above. For example, where enhanced bitmaps of gradient characteristics are generated, as described above, processing of the enhanced bitmaps allows detection of lines that would not have been detected via processing of the original bitmaps.

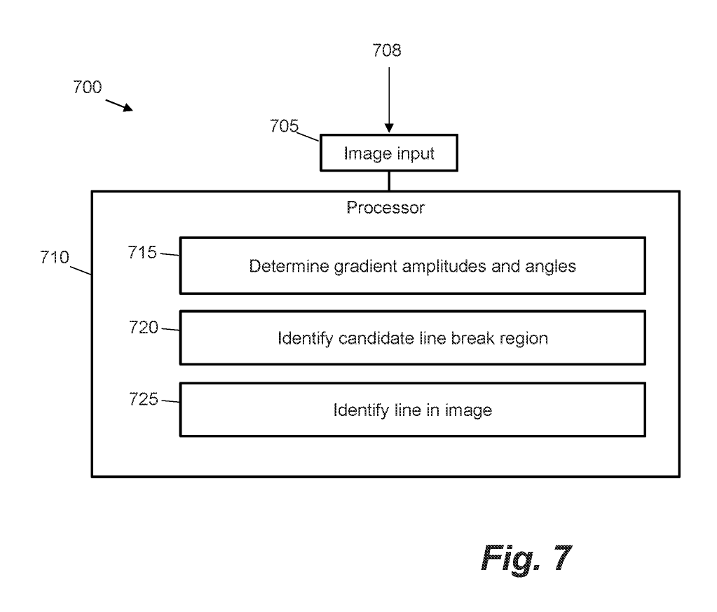

FIG. 7 shows an apparatus 700 for detecting a line in an image according to an example. The apparatus 700 comprises an input 705 configured to receive an image 710. The apparatus 700 further comprises a processor 710. The processor could for example be a central processing unit or a graphics processing unit. The apparatus may include other elements, such as camera optics and related hardware, a memory for storing images, and/or an output interface to output images and/or data representing detected lines. The apparatus may form part of a camera.

The processor 700 is configured to determine 715 a gradient amplitude and a gradient angle for each of a plurality of pixels of the image, for example as described above.

The processor 700 is then configured to identify 720 a candidate line break region in the image. Identifying the candidate line break region comprises identifying a first pixel of the plurality and a second pixel of the plurality, between which the candidate line break region appears. The first pixel has a first quantised gradient angle and the second pixel has a second quantised gradient equal to the first gradient angle, the first pixel and second pixel each have a predefined gradient amplitude characteristic, and the pixel or pixels of the candidate line break region do not have the predefined amplitude characteristic.

The processor is then configured to, at 725, identify a line in the image, wherein the line passes through the candidate line break region.

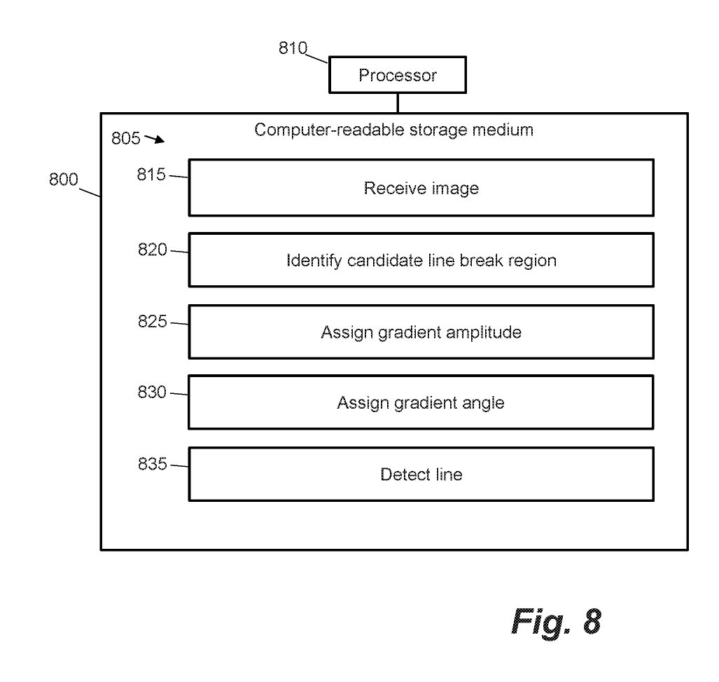

FIG. 8 shows an example of a non-transitory computer-readable storage medium 800 comprising a set of computer readable instructions 805 which, when executed by at least one processor 810, cause the at least one processor 810 to perform a method according to examples described herein. The computer readable instructions 805 may be retrieved from a machine-readable media, e.g. any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read only memory (ROM), an erasable programmable read-only memory, or a portable disc.

At block 815, the instructions 805 cause the processor 810 to receive from an input an image.

At block 820, the instructions 805 cause the processor 810 to identify a candidate line break region in the image, wherein identifying the candidate line break region comprises identifying a first pixel of the image and a second pixel of the image, between which the line break candidate appears. The first pixel has a first gradient angle and the second pixel has a second gradient angle with a predetermined relationship to the first gradient angle.

At block 825, the instructions 805 cause the processor 810 to assign to each pixel of the candidate line break region a gradient amplitude based on at least one of a gradient amplitude of the first pixel and a gradient amplitude of the second pixel.

At block 830, the instructions 805 cause the processor 810 to assign to each pixel of the candidate line break region a gradient angle based on at least one of the first gradient angle and the second gradient angle.

At block 835, the instructions 805 cause the processor 810 to, based on the assigned gradient angle and assigned gradient amplitude, detect a line in the image.

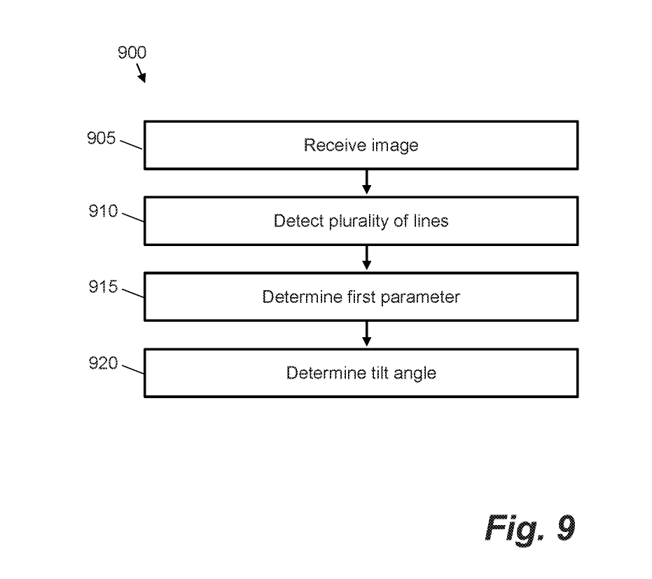

FIG. 9 shows a flow chart of a method 900 for detecting a tilt angle between a camera coordinate system and a world coordinate system, according to an aspect of the present disclosure. The camera coordinate system represents the camera axes, in particular the horizontal and vertical axes of the image sensor of the camera. The world coordinate system exists independently of the camera position and represents axes in a real world environment into which the camera may be introduced. The camera may be in a mobile device, and may constantly or intermittently move relative to the real world environment. The camera may be in a fixed device which is mounted in a fixed position relative to the real world environment. As an example, the camera may be wall-mounted. For example, the world coordinate system may represent axes defined relative to the Earth, in particular horizontal and vertical axes which exist at the location on Earth in which the camera is located. As another example, the world coordinate system may represent axes defined by an environment inside which the camera is located, such as an aeroplane, a train, or an automobile. As such, the tilt angle may be a tilt angle of a camera relative to a physical coordinate system of a three-dimensional physical space, such as the inside of a room or suchlike, in which the camera is located.

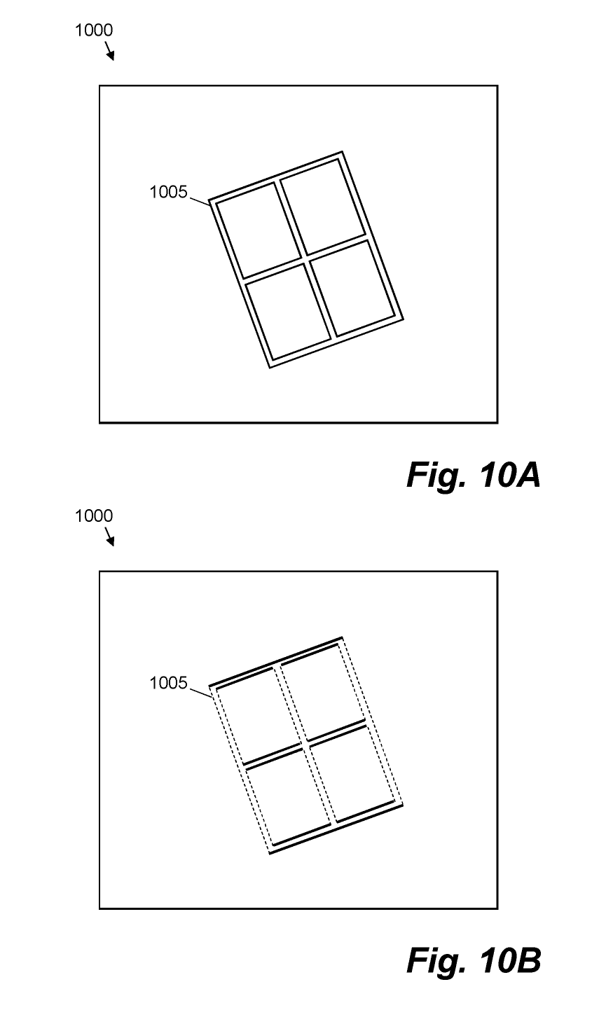

The method 900 comprises receiving 905 an image. FIG. 10A shows an example 1000 of such an image. In this case, the image 1000 is of a window 1005. It can be seen that the window 1005 is at an angle of roughly 20° to the horizontal as a consequence of the camera that captured the image having a tilt angle of 20° to the horizontal. The method 900 then comprises detecting 910 a plurality of lines in the image 10000, wherein each line has an associated angle. In the present example, the detected plurality of lines comprises the lines of the window 1005. The plurality of lines may be detected using line detection algorithms such as those previously described in the present disclosure. Where the detected lines are expressed as equations, the angle of each line may be determined from the equations.

At 915 the method comprises, based on at least a first set of the lines, determining at least a first parameter indicating a first representative angle corresponding to the first set. For example, the first parameter may be an average angle of lines of the first set, where the average may be any average such as the mean, median or mode. The method then comprises determining 920 the tilt angle based on at least the first parameter. In this manner, the method 900 allows detection of the tilt angle without requiring any external sensors or any other input other than the image itself. The tilt angle of a camera may thus be determined without the cost and complexity associated with providing a tilt sensor.

It is frequently the case for such images that lines in the image are more likely to lie at certain angles relative to the world coordinate system. For example, in the image 1000, the lines forming the window 1005 are aligned with the vertical and horizontal axes in the world coordinate system. As such, in the camera coordinate system, the vertical lines of the window 1005 have an angle of 20° to the vertical dimension of the image 1000, and the horizontal lines of the window 1005 have an angle of 20° to the horizontal dimension of the image 1000. In general, this dependency depends on the environment in which the image was captured. For example, an exterior image of an urban scene might be expected to comprise vertical and horizontal lines corresponding to the edges of buildings, doors, windows, and so on.

In some aspects of the present disclosure, the first set of lines comprises lines with corresponding angles within a first range, and the method 900 comprises identifying the first representative angle as corresponding to a first axis of the coordinate system. For example, the method 900 may comprise identifying the first set as the set of all lines with angles within a given angle of the horizontal dimension of the image, for example all angles within 45° of the horizontal dimension of the image. FIG. 10B shows the image 1000, with all such lines shown as solid lines and the remaining lines shown as dashed lines. It can be seen that the lines thus selected are the horizontal lines of the window 1005. As described above, the first representative angle may then be calculated as the average angle of the first set of lines. As the lines of the first set all lie at 20° to the horizontal, the representative angle would thus be an angle of 20° to the horizontal. In the present example, as the first set of lines are assumed to be horizontal in the world coordinate system, the first axis of the world coordinate system is a horizontal axis of the world coordinate system. In this case, the method 900 comprises determining the tilt angle based on at least an angle of the first axis relative to the image. For example, in the example of FIGS. 10A and 10B the tilt angle may be determined as equal to the angle of the first axis relative to the image. In this case, the tilt angle would be correctly determined to be 20°.

Similarly, the first axis may be a vertical axis of the world coordinate system, and the method may thus comprise determining the tilt angle based on at least an angle of this first axis relative to the image. In this example, the first set of lines may be determined as the set of lines with angles within a given range of the vertical dimension of the image, for example within 45° of the vertical dimension of the image. In the example image 1000, the vertical lines of the window 1005 all lie at an angle of 20° to the vertical dimension of the image. It can thus be seen that, analogously to the description above of the horizontal case, if the first set of lines is selected as the set of lines within 45° of the vertical dimension of the image, the first representative angle may be calculated as 20° to the vertical dimension of the image. Accordingly, the first axis may be determined to lie at an angle of 20° to the vertical, and thus the tilt angle may be determined as 20°.

In some examples, either of the above-described horizontal and vertical cases may be selected based on knowledge of the environment in which the camera is positioned. For example, if the camera is positioned in an area with many tall buildings, it might be expected that an image produced by the camera would comprise more vertical lines than horizontal lines. In this situation, the first set of the lines may be selected such that the first axis is a vertical axis and not a horizontal axis, as this may produce more accurate results.

In one aspect of the present disclosure the method 900 comprises, based on at least a second set of the lines, determining at least a second parameter indicating a second representative angle corresponding to the second set. The method then comprises determining the tilt angle based on at least one of the first parameter and the second parameter. The second set of lines may comprise lines with corresponding angles within a second range. For example, where the first representative angle is identified as corresponding to one of a horizontal axis and a vertical axis of the world coordinate system, the method 900 may comprise identifying the second representative angle as corresponding to the other of the horizontal axis and the vertical axis of the world coordinate system. The tilt angle may then be determined based on at least one of an angle of the first axis relative to the image and an angle of the second axis relative to the image.

As an example of this aspect of the invention, the method 900 may comprise selecting a preferred one of the first and second sets of lines, and determining the tilt angle based at least on the parameter corresponding to the selected set. The preferred one of the first and second sets may be selected based on a predefined characteristic of the image. For example, as explained above, one of the first and second sets may be expected to produce more accurate tilt angle results, depending on the environment in which the camera is situated. The at least one of the first and second sets may thus be selected depending on the camera environment as the set which is most likely to produce accurate results. As another example, the selected set may be the set comprising the largest number of lines. Alternatively, the method 900 may comprise calculating an uncertainty corresponding to the first set and an uncertainty corresponding to the second set. The uncertainties may for example comprise statistical uncertainties of the respective representative angles. The method may then comprise selecting at least one of the first and second sets based on the calculated uncertainties. For example, the set with lowest uncertainty may be selected. Similarly, a weighted average, such as a weighted mean, of angles of lines in both sets may be used to determine the tilt angle, with more weight being given to the set with lower uncertainty.

In some examples, the method 900 comprises determining the tilt angle based on an assumed relationship between the first representative angle and the second representative angle. For example, where the first axis (to which the first representative angle corresponds) is a horizontal axis of the world coordinate system and the second axis (to which the second representative angle corresponds) is a vertical axis of the world coordinate system, it may be assumed that there is a right-angle relationship between the first representative angle and the second representative angle. The tilt angle may then be determined based on the first and second representative angles, with the assumption that they have this relationship.

In some examples, the method 900 comprises identifying a candidate line break region in the image. As described above, identifying the candidate line break region may comprise identifying a first pixel of the image and a second pixel of the image, between which the candidate line break region appears. In this example, the first pixel has a first characteristic and the second pixel has a second characteristic with a predetermined similarity relationship to the first characteristic. The method then comprises using the identified candidate line break region to assist in detecting a line in the image.

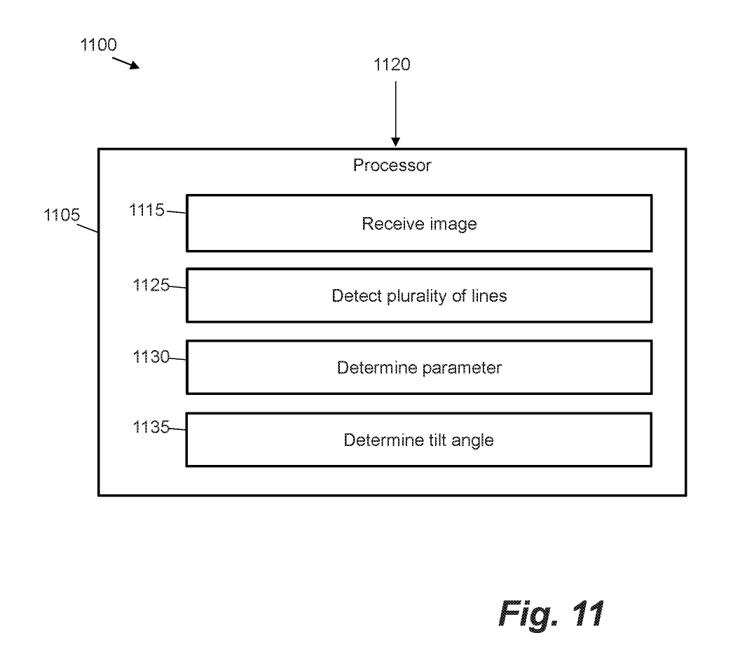

FIG. 11 shows an apparatus 1100 for detecting a tilt angle between a camera coordinate system and a world coordinate system according to an example. The apparatus comprises a processor 1105 configured to receive 1115 an image 1120 from a camera. The camera may for example be a video camera or a static camera. Where the camera is a video camera, the image may be a frame of a video. The apparatus may be the apparatus depicted in FIG. 7 and described above. The processor may for example be a central processing unit or a graphics processing unit. The apparatus may include other elements, such as camera optics and related hardware, a memory for storing images, and/or an output interface to data representing the tilt angle. The apparatus may form part of a camera.

The processor 1105 is configured to detect 1125 a plurality of lines in the image, wherein each detected line has an associated angle. The lines may be detected using a line detection algorithm, for example as described above.

The processor 1105 is then configured to, based on at least a set of the lines, determine 1130 at least a parameter indicating a first representative angle corresponding to the first set. For example, as described above, the parameter may be an average, for example the mean or median, of the angles of the set of lines.

The processor 1105 is configured to determine 1135 a tilt angle based on at least the parameter, for example as disclosed above. The tilt angle may for example be a mounting angle of the camera, indicating an angle at which the camera is mounted relative to its surroundings.

In some examples, the processor is configured to receive the image and determine the tilt angle in real time. For example, where the camera is a video camera in motion relative to its surroundings, the processor may determine in real time a tilt angle value that changes from frame to frame as the angle of the camera changes relative to its surroundings.

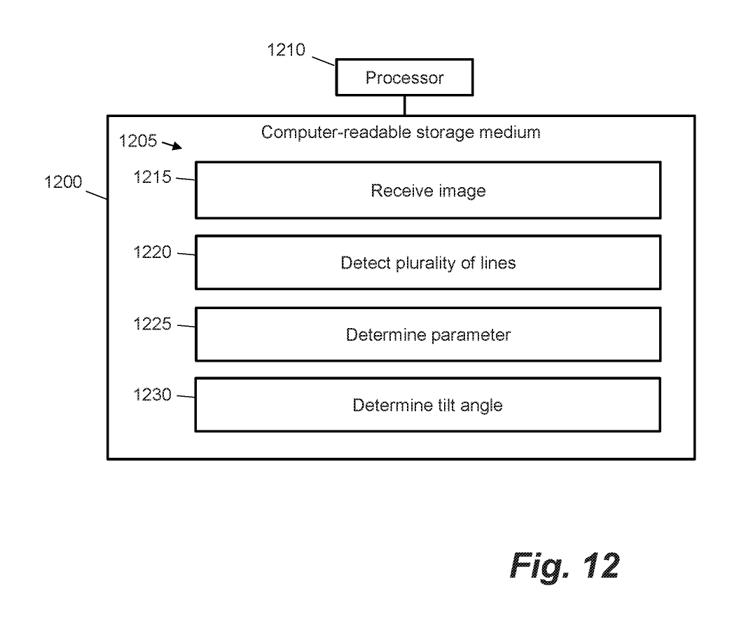

FIG. 12 shows an example of a non-transitory computer-readable storage medium 1200 comprising a set of computer readable instructions 1205 which, when executed by at least one processor 1210, cause the at least one processor 1210 to perform a method according to examples described herein. The computer readable instructions 1205 may be retrieved from a machine-readable media, e.g. any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read only memory (ROM), an erasable programmable read-only memory, or a portable disc.

At block 1215, the instructions 1205 cause the processor 1210 to receive an image from a camera.

At block 1220, the instructions 1205 cause the processor 1210 to detect a plurality of lines in the image, wherein each detected line has an associated angle.

At block 1225, the instructions 1205 cause the processor 1210 to, based on at least a set of detected lines with angles within a predefined angular range, determine at least a parameter indicating an average angle of the lines of the set. For example, as described above the set may comprise angles within a predefined range centred on a vertical or horizontal dimension of the image.

Finally, at block 1230, the instructions 1205 cause the processor 1210 to determine a tilt angle between a camera coordinate system and a world coordinate system based on at least the parameter.

The above embodiments are to be understood as illustrative examples of the invention. Alternatives are envisaged. For example, instead of amending a bitmap of gradient characteristics to produce an enhanced bitmap as described above, candidate line break regions may be stored separately and retrieved when detecting lines in the image. As another alternative, the apparatus shown in FIG. 7 and/or the apparatus shown in FIG. 11 may not form part of a camera but may instead be a remote processing device configured to receive images over a network. Where the tilt angle is determined for frames of a video, the apparatus described above may, instead of outputting in real time information indicating the tilt angle, output an overall value indicating an average tilt angle and/or a variance of the tilt angle. The tilt angle may be displayed to a user, for example with an indication to the user to move the camera to reduce the tilt angle. Information indicating the tilt angle and/or lines detected in an image may be stored in metadata associated with the image. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method for detecting a tilt angle between a camera coordinate system and a world coordinate system, the method comprising:
receiving an image;
detecting a plurality of lines in the image, wherein each detected line has an associated angle;
based on at least a first set of the lines, determining at least a first parameter indicating a first representative angle corresponding to the first set; and
determining the tilt angle based on at least the first parameter.

2. A method according to claim 1, wherein the first set of lines comprises lines with corresponding angles within a first range, the method comprising:
identifying the first representative angle as corresponding to a first axis of the world coordinate system.

3. A method according to claim 2, wherein the first axis is a horizontal axis of the world coordinate system, and wherein the method comprises determining the tilt angle based on at least an angle of the first axis relative to the image.

4. A method according to claim 2, wherein the first axis is a vertical axis of the world coordinate system, and wherein the method comprises determining the tilt angle based on at least an angle of the first axis relative to the image.

5. A method according to claim 1, comprising:
based on at least a second set of the lines, determining at least a second parameter indicating a second representative angle corresponding to the second set; and
determining the tilt angle based on at least one of the first parameter and the second parameter.

6. A method according to claim 5, the method comprising:
identifying the first representative angle as corresponding to one of a horizontal axis and a vertical axis of the world coordinate system; and
identifying the second representative angle as corresponding to the other of the horizontal axis and the vertical axis of the world coordinate system.

7. A method according to claim 6, comprising:
selecting a preferred one of the first and second sets; and
determining the tilt angle based at least on the parameter corresponding to the selected set.

8. A method according to claim 7, comprising selecting said preferred one of the first and second sets based on a predefined characteristic of the image.

9. A method according to claim 7, comprising:
calculating an uncertainty corresponding to the first set and an uncertainty corresponding to the second set;
selecting at least one of the first and second sets based on the calculated uncertainties.

10. A method according to claim 6, comprising determining the tilt angle based on an assumed relationship between the first representative angle and the second representative angle.

11. A method according to claim 1, the method comprising:
identifying a candidate line break region in the image, wherein identifying the candidate line break region comprises identifying a first pixel of the image and a second pixel of the image, between which the candidate line break region appears, wherein:
the first pixel has a first characteristic and the second pixel has a second characteristic with a predetermined similarity relationship to the first characteristic, and
using the identified candidate line break region to assist in detecting a line in the image.

12. An apparatus for detecting a tilt angle between a camera coordinate system and a world coordinate system, the apparatus comprising a processor configured to:
receive an image from a camera;
detect a plurality of lines in the image, wherein each detected line has an associated angle;
based on at least a set of the lines, determine at least a parameter indicating a first representative angle corresponding to the first set; and
determine the tilt angle based on at least the parameter.

13. An apparatus according to claim 12, wherein the processor is configured to receive the image and determine the tilt angle in real time.

14. An apparatus according to claim 12, wherein the tilt angle is a mounting angle of the camera.

15. A non-transitory computer-readable storage medium comprising a set of computer-readable instructions stored thereon which, when executed by at least one processor, cause the at least one processor to:
receive an image from a camera;
detect a plurality of lines in the image, wherein each detected line has an associated angle;
based on at least a set of detected lines with angles within a pre-defined angular range, determine at least a parameter indicating an average angle of the lines of the set; and
determine a tilt angle between a camera coordinate system and a world coordinate system based on at least the parameter.
